(19) United States
(12) Patent Application Publication
(10) Pub. No.: US 2003/0197108 A1
(43) Pub. Date: Oct. 23, 2003

(54) Device for holding rebar rods

(76) Inventor: George Domizio, Oxford, CT (US)

Correspondence Address: BACHMAN & LAPOINTE, P.C., 900 CHAPEL STREET, SUITE 1201, NEW HAVEN, CT, 06510, US

(21) Appl. No.: 10/361,962

(22) Filed: Feb. 10, 2003

Related U.S. Application Data
(60) Provisional application No. 60/355,533, filed on Feb. 8, 2002.

(51) Int. Cl. F16M 13/00

(52) U.S. Cl. 248/519; 248/346.01

(57) ABSTRACT

A device for holding a plurality of elongate members, including a base; and structure extending from the base and defining a plurality of seats for holding intersecting elongate members.

### BACKGROUND OF THE INVENTION

The invention relates to an apparatus for holding elongated rod-like material such as rebar, particularly for holding rebar which must be positioned in intersecting configurations.

Rebar and other materials must frequently be positioned in grids and the like, for example-in manufacture of concrete members reinforced with such rebar. When such rebar rods are to be positioned in intersecting configurations, difficulties are encountered in holding the rebar in the proper position.

It is the primary object of the present invention to provide an apparatus for addressing this difficulty.

### SUMMARY OF THE INVENTION

In accordance with the present invention, the foregoing object is readily attained.

According to the invention, a support member is provided which defines channels or seats for intersecting rebar members, and which preferably includes dowel members and receptacle structures, or the like, to allow the supports to be stacked, for example when multiple supports are desired.

A cover member is also provided, which can advantageously be configured to clamp to and hold or support other routinely encountered structures such as wire mesh, for example.

In accordance with a further embodiment of the present invention, a support is provided wherein rebar can be held at 45° and/or 90° angles, and further wherein the seat for the rebar includes an engaging member whereby the support can be rotated so as to clampingly engage the rebar members to be held.

### BRIEF DESCRIPTION OF THE DRAWINGS

A detailed description of preferred embodiments of the present invention follows, wherein:

FIGS. 1-3 collectively illustrate one preferred embodiment of the present invention;

FIGS. 4 and 5 illustrate an alternative embodiment of the invention with simplified structure;

FIGS. 6 and 7 illustrate still further embodiments of the present invention;

FIGS. 8 and 9 illustrate a further embodiment of the apparatus in accordance with the present invention;

FIGS. 10-12 illustrate a further embodiment of a cover for a rebar support member in accordance with the present invention;

FIG. 13 is a perspective view showing a further embodiment of the seat portion for holding a rebar member;

FIGS. 14 and 15 illustrate a further embodiment of the present invention for holding rebar members at 45° angles; and

FIG. 16 illustrates a further embodiment of the present invention for supporting a holder on loose surfaces.

### DETAILED DESCRIPTION

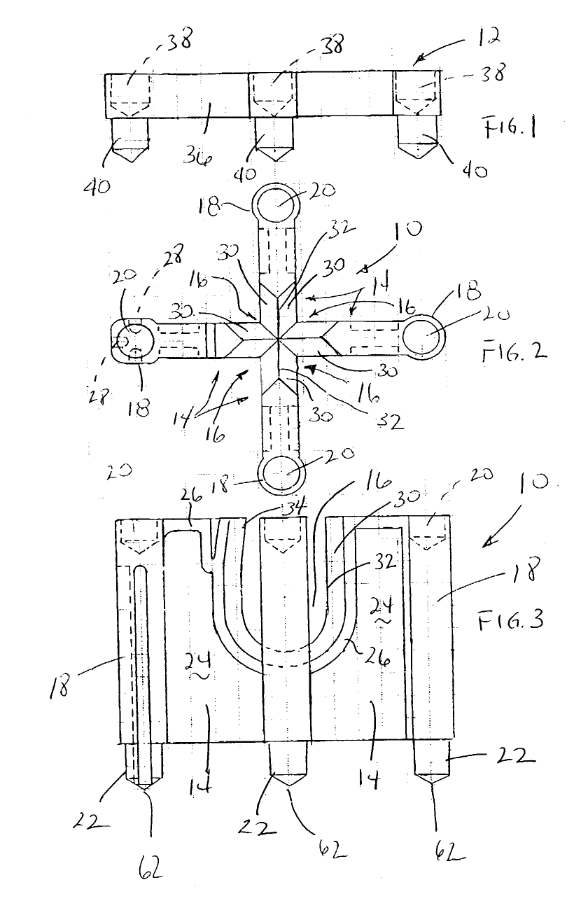

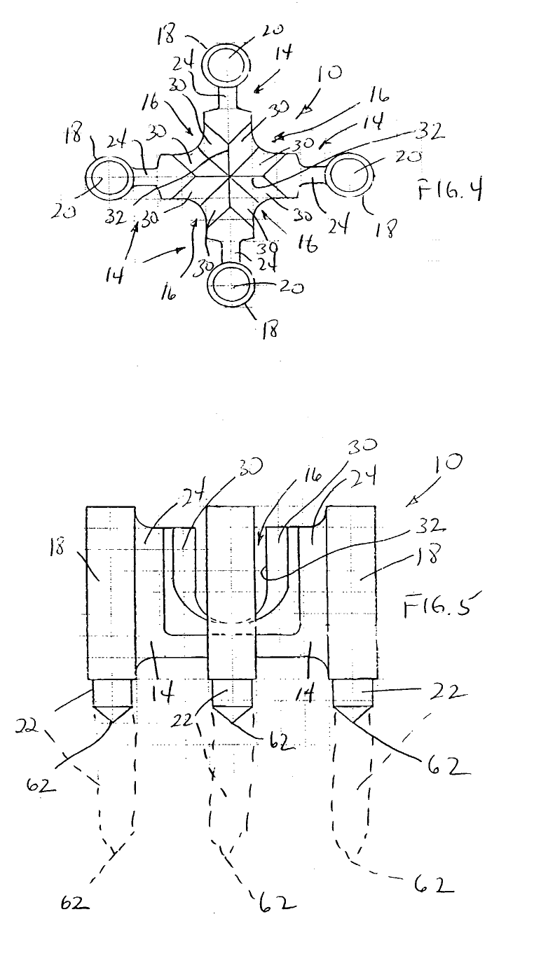

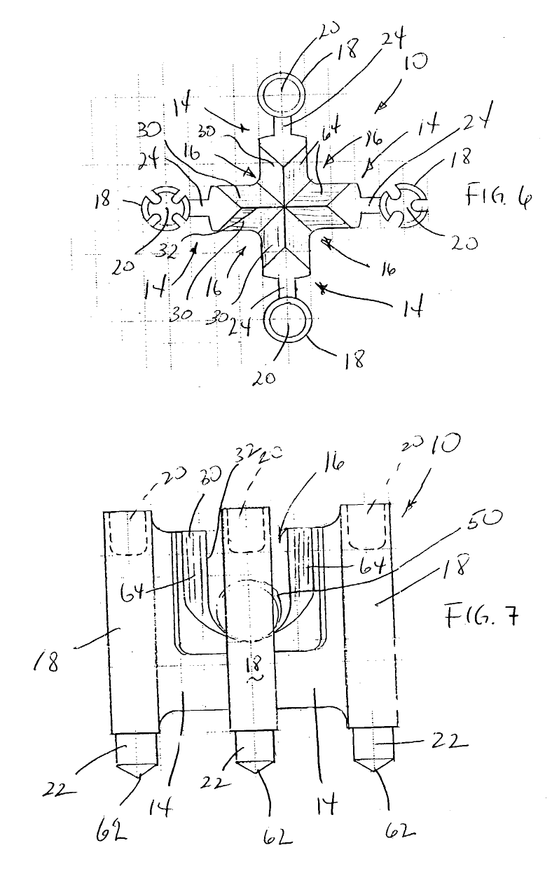

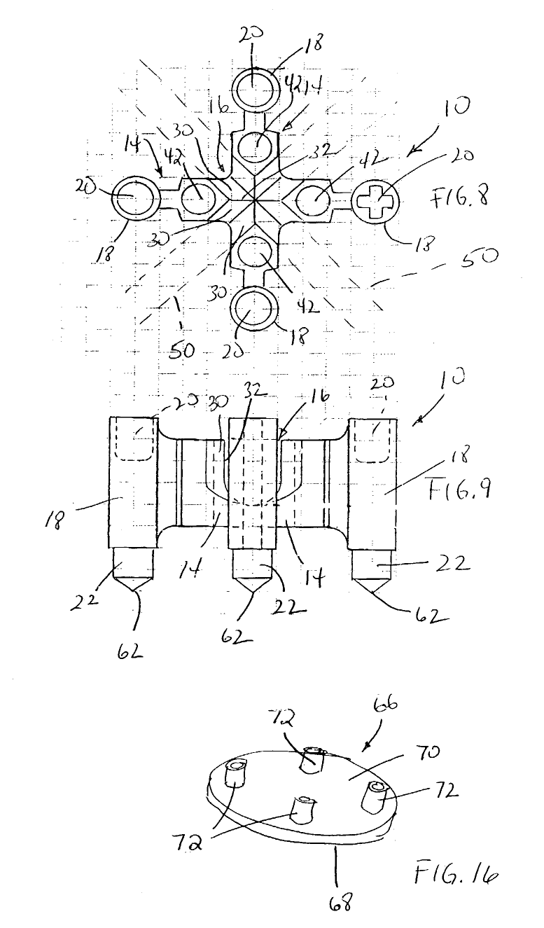

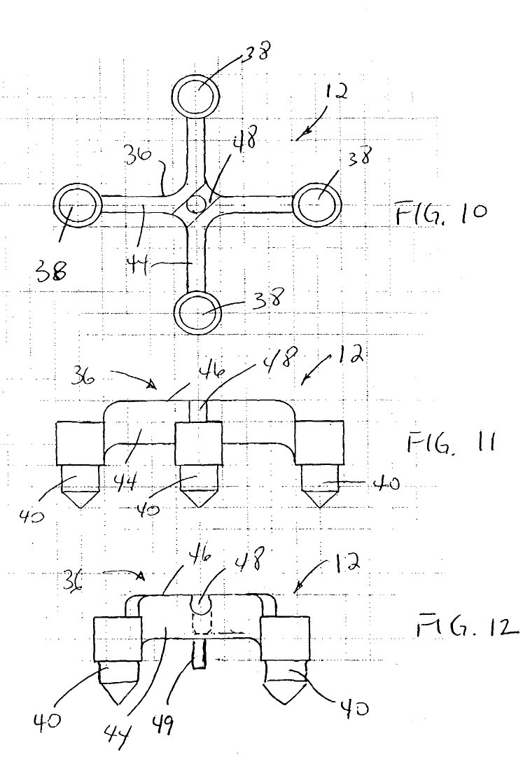

The invention relates to a support member for holding and supporting intersecting rod-like members such as rebar. FIGS. 1-3 collectively show an embodiment in accordance with the present invention, wherein FIGS. 2 and 3 illustrate the holder 10, and FIG. 1 illustrates a cover 12 for same.

In accordance with the present invention, holder 10 has arm members 14, in this case four arm members extending from a central portion and spaced at 900 angles from each other. Arm members 14 advantageously define seats 16 for receiving elongated members such as rebar and the like. In the embodiment shown in FIGS. 1-3, each seat 16 is defined as an upwardly open substantially U-shaped seat, into which rebar can be positioned, and each seat 16 is defined by portions of two arm members 14. Of course, other shapes of seats 16 can be provided.

Arm members 14 further include interlockable structures to allow holders 10 to be stacked. In this embodiment, dowels 18 are provided, each of which advantageously has a receptacle 20 and a protruding member 22, with protruding member 22 sized to be engaged with a receptacle 20 of another holder 10 such that holders 10 can be stacked as desired.

FIGS. 2 and 3 show arm members 14 having a minimal thickness portion 24 with a ridge extending along upper edges 26 and, preferably, along seats 16, as well, for structural strength. This advantageously provides a structure having sufficient strength, while nevertheless saving in material, weight and the like.

Cutouts 28 can also be positioned, if desired, along dowels 18 so as to further save in materials and weight of the device, while nevertheless providing the desirable structural strength.

Still referring to FIGS. 2 and 3, seats 16 are preferably defined by walls having tapered surfaces 30, which may advantageously be tapered to a point 32, such that surfaces 30 can provide for snug engagement with intersecting rebar rods, for example positioned at 90° angles with respect to each other. Thus, each arm 14 preferably has two surfaces 30, each positioned substantially parallel to a surface 30 of an adjacent arm 14 as shown.

Referring to FIG. 3, it may be desirable to provide a retaining member 34, which may for example be a portion of the arm member 14 defining seats 16, and which extends inwardly, toward an opposed wall of seat 16, so as to define a reduced-width access portion at the top of seat 16, beyond which a rebar rod must be forced to position properly as desired. Retaining member 34 advantageously helps to hold rebar member in place within holder 10 as desired. This function can also be provided by forming walls or other structure that defines seats 16 to taper inwardly as well, so as to provide a press fit of rebar into seat 16.

FIG. 1, as described above, illustrates a cover member 12 for holder 10, and advantageously includes a substantially flat body portion or member 36, preferably a cross-shaped member as shown, and preferably having receptacles 38 and protruding members 40 adapted to engage receptacles 20, and be engaged by protruding members 22, of holder 10. In this manner, cover member 12 can be used to completely secure rebar members held within seats 16, and further can be used as a spacer for assembly of holders 10 and covers 12 to provide for a desired configuration.

FIGS. 4 and 5 illustrate an alternative embodiment of holder 10 in accordance with the present invention, wherein the interlocking structure is provided as dowel members 18 having a substantially round shape with protruding members 22 and receptacles 20 defined thereon, and wherein seats 16 are defined with a greater thickness to provide for additional structural strength. In addition, arm members 14 between the portion defining seats 16 and dowels 18 is entirely, in this embodiment, of the minimal thickness dimension.

Turning to FIGS. 6 and 7, a further embodiment of holder 10 in accordance with the present invention is shown, wherein arm members 14 have substantially the same structure defining seats 16 as is shown in the embodiment of FIGS. 4 and 5. In this embodiment, however, dowels 18 are provided having several cutouts which can be provided, on receptacles 20 if desired so as to engage with protruding members 22 with a force fit, thereby providing a secure and reliable engagement therewith.

FIGS. 8 and 9 illustrate still another embodiment of the present invention wherein arm members 14 are provided having additional receptacles 42, and wherein some or all receptacles 20 are provided having still a different configuration to allow for desirable force fit engagement with protruding members 22 of other holders 10. This holder is, in all other respects, identical to those of previous embodiments. Additional receptacles 42 can advantageously be used to receive vertical rods that can be used for spacing vertically adjacent holders 10 as desired.

FIGS. 10-12 illustrate an alternative embodiment of a cover 12 in accordance with the present invention, wherein arm members 14 further include a raised portion 44 defining a surface 46 which is spaced above the upper edge of receptacles 38, and further which defines an additional engaging structure 48 which can clamp to or secure other members such as wire mesh and the like.

FIG. 12 further illustrates another embodiment of the present invention wherein a post 49 is positioned extending downwardly from cover 12, preferably at a central location thereof, so as to engage and hold rebar positioned under same, in a holder 10 to which cover 12 is fixed.

The raised portion 44 of arms 14 in accordance with the embodiment of FIG. 12 further serves to leave a gap between the substantial portion of bottom surfaces of arms 14 and rebar members positioned thereunder such that concrete can reach and maximize surface contact with rebar members as desired.

Turning now to FIG. 13, a further alternative embodiment of an invention is shown, in a perspective view, and engaged with a rebar member 50 as desired. In this embodiment, seats 16 are defined in walls 52 of a substantially round holder 54, and seats 16 further include a laterally protruding member 56 behind which rebar member 50 can be pivoted to more securely engage with holder 54 as desired.

In this embodiment, as well, rebar members 50 can advantageously be engaged and held in intersecting configurations as desired. In this embodiment, the rebar members would advantageously be positioned as desired, and then round holder 54 can advantageously be positioned over rebar members 50 and then pivoted as shown by the arrow in FIG. 13 to engage rebar members behind laterally protruding members 56 as desired.

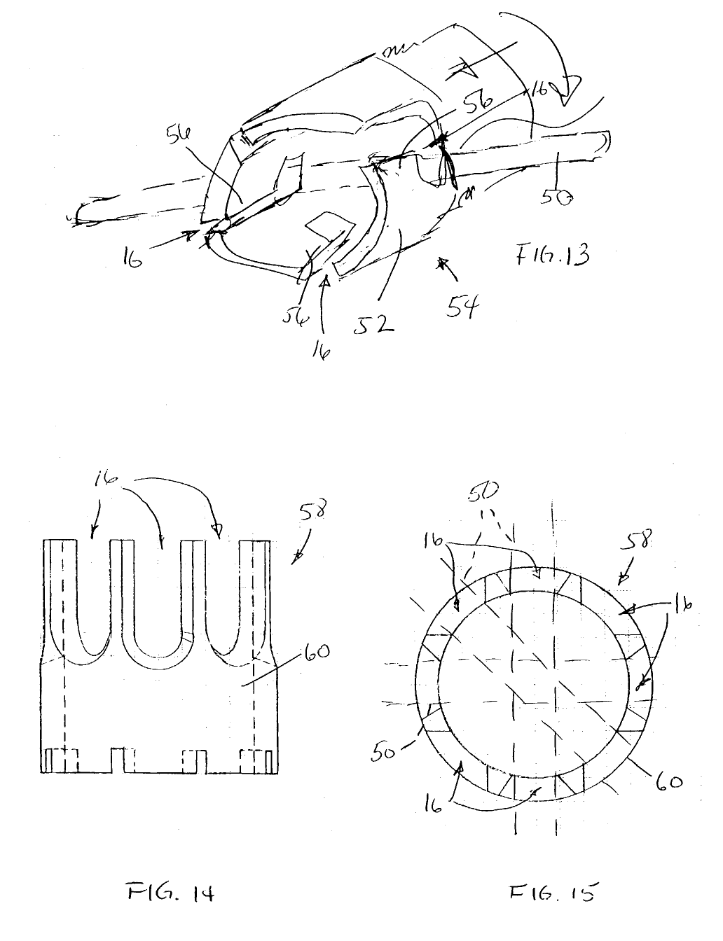

Turning now to FIGS. 14 and 15, a further embodiment of a holder 58 in accordance with the present invention is shown. In this embodiment, as in the embodiment of FIG. 13, seats 16 are defined in walls 60 of substantially round holder 58. Further, eight seats 16 are defined in this embodiment, rather than four, so as to allow for intersecting rebar members at 450 angles as well.

In use, the various embodiments of the present invention are used to secure rebar members in intersecting configurations as desired, for example to assist in positioning of such rebar members within formed concrete fabrications and the like, such that the rebar reinforces the concrete as desired, and is reliably held in place, particularly while concrete is being poured.

The holder in accordance with the present invention can advantageously be formed from any material suitable to the desired end use. One particularly preferred material from which holders can advantageously be formed is glass-filled polypro material, which is a material having sufficient rigidity for the desired use. Of course, other materials could be used as well.

Referring back to the Figures in general, protruding members 22 of holders 10 in accordance with the invention are shown having pointed ends 62, and these pointed ends 62 are advantageous for several reasons. First, they help guide protruding members 22 into an associated receptacle 20. In addition, holder 10 is frequently used to support rebar spaced from an outer surface of the concrete article to be fabricated, and holder 10 can therefore frequently be positioned resting directly upon a wall of the mold for pouring the concrete.

Pointed ends 62 minimize the amount of the support that can be seen after the article is removed from the mold. This is particularly advantageous as compared to larger surface-area “feet” or other support members which may otherwise be positioned thereon, and which would readily be visible from the outside surface of the fabricated concrete article.

In accordance with a further embodiment of the present invention, and as illustrated in dashed lines in FIG. 5, protruding members 22, or some other structure from which protruding members 22 extend, can be provided having additional length, beyond that which is sufficient to engage receptacles 20, such that holder 10 can be itself used as a spacer as well. In this regard, this feature, combined with receptacles 20 having a depth substantially the entire length of dowels 18, can allow for variable spacing using the same holders in accordance with the present invention, by forcing protruding members 22 into receptacles 20 only to the extent desired so as to provide a suitable spacing between holders.

Returning to FIG. 6, wall faces 30 may advantageously be provided with a series of vertical ridges 64 which can advantageously be used to further enhance grip of rebar positioned in seats 16 defined by same. Ridges 64 can advantageously be positioned so as to extend inwardly and provide for a press fit with the rebar positioned therebetween, which greatly enhances the hold on rebar as desired.

Turning now to FIG. 16, a further embodiment of the present invention is provided, which is a plate 66 that can advantageously be used to support a holder 10 when is to be positioned on a loose surface, rather than on the solid wall of a mold into which concrete is to be poured. Plate 66 advantageously is a substantially planar member having a bottom surface 68 adapted to rest on such loose material, and an upper surface 70 from which extend receptacles 72, or on which are defined other suitable receiving structures, for receiving protruding members 22 of a holder 10 such as that described above. This advantageously allows for the reliable positioning of a holder 10 in accordance with the present invention, even on loose sand or other surfaces.

It should also be noted that although the description of the preferred embodiment is provided in terms of holding rebar for fabricating concrete structures, holder 10, 54 58 in accordance with the various embodiments of the present invention could advantageously be used for securing other elongated members in other applications as well.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications which are within its spirit and scope as defined by the claims.

What is claimed is:

1. A device for holding a plurality of elongate members, comprising:
a base; and
structure extending from said base and defining a plurality of seats for holding intersecting elongate members.

2. The device of claim 1, wherein said base has a bottom and a top and said structure defines said seats opening toward said top.

3. The device of claim 1, wherein said base comprises at least two intersecting arms, and wherein said arms have substantially U-shaped openings defined therein, said U-shaped openings defining said seats.

4. The device of claim 3, wherein said U-shaped openings are defined by walls tapered surfaces, and wherein adjacent surfaces of adjacent U-shaped openings are substantially parallel.

5. The device of claim 1, wherein said base has a bottom and a top, and further comprising engaging structures positioned on said bottom and said top whereby a plurality of said devices can be stacked and engaged with another device.

6. The device of claim 5, wherein said engaging structures comprise a plurality of extending members extending from one of said bottom and said top and a plurality of apertures on the other of said bottom and said top.

7. The device of claim 1, further comprising a cover adapted to engage said device and hold said elongate members in said plurality of seats.

8. The device of claim 7, wherein said cover has a first surface adapted to engage said base and a second surface defining an additional engaging structure.

9. The device of claim 7, wherein said cover further includes a post extending toward said base for contacting said elongate members in said plurality of seats.

10. The device of claim 1, further comprising a support plate having a first side adapted to secure to said base and a second side defining a flat support surface.

11. The device of claim 1, wherein said seats further have a laterally offset extension adapted to receive said plurality of elongate members.
